(19) United States
(12) Patent Application Publication
(10) Pub. No.: US 2022/0405420 A1
(43) Pub. Date: Dec. 22, 2022

(54) PRIVACY PRESERVING DATA STORAGE

(71) Applicant: International Business Machines Corporation, Armonk, NY (US)

(72) Inventors: Pierpaolo Tommasi, Dublin (IE); Marco Simioni, Dublin (IE)

(21) Appl. No.: 17/352,756

(22) Filed: Jun. 21, 2021

(51) Int. Cl. G06F 21/62; G06F 21/78; G06F 21/60

(52) U.S. Cl. CPC G06F 21/6245; G06F 21/6209; G06F 21/78; G06F 21/602; G06F 2221/0751

(57) ABSTRACT

One or more pieces of data are received. The one or more pieces of data are anonymized. The one or more pieces of data are encrypted. The anonymized one or more pieces of data and the encrypted one or more pieces of data are stored.

### BACKGROUND

The present invention relates generally to the field of data storage, and more particularly to data privacy in data storage.

It is quite common for data storage to store both personal/sensitive data. Several people/organizations may access this data for several different purposes. For example, a user may want to access data in order to update/modify/delete their information. In another example, a data scientist may want to access aggregated and/or partial data in order to carry out data analysis on parts of the data.

### SUMMARY

Embodiments of the present invention disclose a computer-implemented method, a computer program product and a system for managing data. In one embodiment, one or more pieces of data are received. The one or more pieces of data are anonymized. The one or more pieces of data are encrypted. The anonymized one or more pieces of data and the encrypted one or more pieces of data are stored.

### BRIEF DESCRIPTION OF THE DRAWINGS

FIG. 1 is a functional block diagram of a network computing environment, generally designated 100, suitable for operation of security program 112, in accordance with at least one embodiment of the invention.

FIG. 2 is a flow chart diagram depicting operational steps for security program 112 for storing private data, in accordance with at least one embodiment of the invention.

FIG. 3 is a flow chart diagram depicting operational steps for security program 112 for providing private data, in accordance with at least one embodiment of the invention.

FIG. 4 is an example of encrypted and anonymized data, in accordance with at least one embodiment of the invention.

FIG. 5 is a block diagram depicting components of a computer, generally designated 400, suitable for executing security program 112, in accordance with at least one embodiment of the invention.

### DETAILED DESCRIPTION

The present invention provides a method, computer program product, and computer system for storing private data and providing private data. In an embodiment, private data may be any personal, personally identifiable, financial, sensitive and/or regulated information, including, but not limited to, credit or debit card information, bank account information or user names and passwords Embodiments of the present invention recognize that some users may be allowed to access private data while some users may want to access some of the data without accessing the private data. Embodiments of the present invention recognize that some users may need access to parts or anonymized pieces of data. Embodiments of the present invention recognize that current solutions for data access rely on access control or materialized views but cannot guarantee that personal and/or sensitive data is not being accessed by users for the wrong purposes or maliciously.

Embodiments of the present invention provide for a program that prevents personal and/or sensitive data from being accessed by unauthorized users while at the same time allowing anonymized data to presented to a user for data analysis. Embodiments of the present invention provide a program and storage system that upon entry of personal and/or sensitive data allow for the storage of an encrypted form and a de-identified/anonymized, unencrypted form. Embodiments of the present invention provide for a user to have access to privacy and/or sensitive data in its pure form as long as the user possesses an unencrypting method. Embodiments of the present invention provide for a user to have access to anonymized unencrypted data that may be used for analytics/statistical purposes or the like. Embodiments of the present invention provide for data storage of personal and/or sensitive data while allowing access to the anonymized version of the data so that data analysis or the like can be performed on said data.

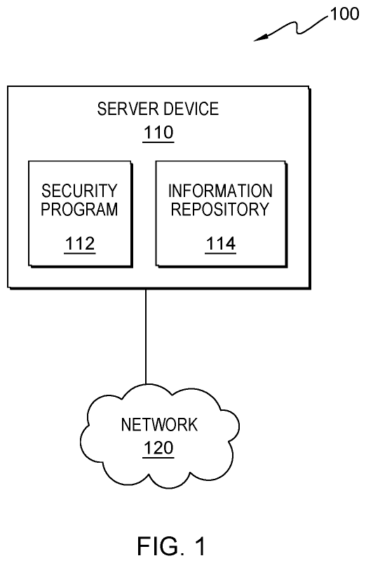

Referring now to various embodiments of the invention in more detail, FIG. 1 is a functional block diagram of a network computing environment, generally designated 100, suitable for operation of security program 112, in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims.

Network computing environment 100 includes server device 110, interconnected over network 120. In embodiments of the present invention, network 120 can be a telecommunications network, a local area network (LAN), a wide area network (WAN), such as the Internet, or a combination of the three, and can include wired, wireless, or fiber optic connections. Network 120 may include one or more wired and/or wireless networks that are capable of receiving and transmitting data, voice, and/or video signals, including multimedia signals that include voice, data, and video formation. In general, network 120 may be any combination of connections and protocols that will support communications between server device 110 and other computing devices (not shown) within network computing environment 100.

Server device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, server device 110 represents any programmable electronic devices or combination of programmable electronic devices capable of executing machine readable program instructions and communicating with other computing devices (not shown) within computing environment 100 via a network, such as network 120.

In various embodiments of the invention, server device 110 may be a computing device that can be a standalone device, a management server, a web server, a media server, a mobile computing device, or any other programmable electronic device or computing system capable of receiving, sending, and processing data. In other embodiments, server device 110 represents a server computing system utilizing multiple computers as a server system, such as in a cloud computing environment. In an embodiment, server device 110 represents a computing system utilizing clustered computers and components (e.g., database server computers, application server computers, web servers, and media servers) that act as a single pool of seamless resources when accessed within network computing environment 100.

In an embodiment, server device 110 includes a user interface (not shown). A user interface is a program that provides an interface between a user and an application. A user interface refers to the information (such as graphic, text, and sound) a program presents to a user and the control sequences the user employs to control the program. There are many types of user interfaces. In one embodiment, a user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, server device 110 includes security program 112 and information repository 114.

Embodiments of the present invention provide for a security program 112 for storing private data. In an embodiment, security program 112 receives data. In an embodiment, security program 112 determines whether the data is privacy preserving. In an embodiment, security program 112 stores the data. In an embodiment, security program 112 encrypts the data. In an embodiment, security program 112 anonymizes the data. In an embodiment, security program 112 stores the encrypted data and the anonymized data.

Embodiments of the present invention provide for a security program 112 for providing privacy data. In an embodiment, security program 112 receives a data request. In an embodiment, security program 112 determines whether the data of the data request is private preserving. In an embodiment, security program 112 transmits the data. In an embodiment, security program 112 determines whether an unencrypting method is received. In an embodiment, security program 112 transmits the anonymized data. In an embodiment, security program 112 transmits the unencrypted data.

In an embodiment, server device 110 includes information repository 114. In an embodiment, information repository 114 may be managed by security program 112. In an alternative embodiment, information repository 114 may be managed by the operating system of server device 110, another program (not shown), alone, or together with, security program 112. Information repository 114 is a data repository that can store, gather, and/or analyze information. In some embodiments, information repository 114 is located externally to server device 110 and accessed through a communication network, such as network 120. In some embodiments, information repository 114 is stored on server device 110. In some embodiments, information repository 114 may reside on another computing device (not shown), provided information repository 114 is accessible by server device 110. In an embodiment, information repository 114 may include data, including, but not limited to, non-private data, private data that has been encrypted, and private data that has been anonymized.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

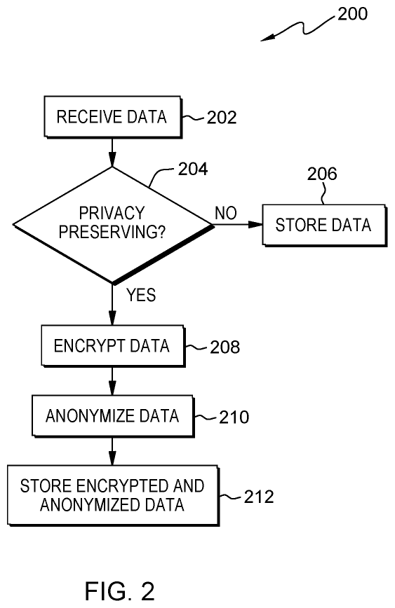

FIG. 2 is a flow chart diagram of workflow 200 depicting operational steps for security program 112 for storing private data in accordance with at least one embodiment of the invention. In an alternative embodiment, the steps of workflow 200 may be performed by any other program (not shown) while working with security program 112. It should be appreciated that embodiments of the present invention provide at least for storing private data. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 200 upon a user wanting to store data in information repository 114.

In an embodiment, security program 112 may include classic access control, such as a user name and password that must be verified and authenticated before allowing workflow 200 and/or workflow 300 to proceed. In an embodiment, security program 112 may be implemented on the server-side which assumes a “trusted” server that allows verification and authentication on the server side. In other words, a single program, security program 112, performs the steps of workflow 200 and/or workflow 300. Workflow 200 and workflow 300 are discussed within the “trusted” embodiment. In an alternative embodiment, security program 112 may be implemented on the client-side or another, external, trusted server which assumes an “untrusted” server that allows verification and authentication on the client side. In other words, some steps of workflow 200 and/or 300 are performed by security program 112 on the “client-side” and some steps are performed by another program (not shown) due to the “untrusted” nature of the server.

Security program 112 receives data (step 202). At step 202, security program 112 receives data to be stored in information repository 114. In an embodiment, security program 112 may receive an indication from a user of one or more data to be stored in information repository 114. In an embodiment, security program 112 may receive an indication from another program (not shown) of one or more data to be stored in information repository 114. In an embodiment, the received data may include a key material, for example a public key that is part of a public/private key encryption mechanism, for encrypting the data and/or an indication of a location where to access a key material, such as a public key that is part of a public/private key encryption mechanism, for encrypting.

Security program 112 determines whether the data is private preserving (decision step 204). In other words, security program 112 determines whether the data being stored needs to have the privacy of the data preserved. In an embodiment, security program 112 determines where the data is to be stored and that storage location determines whether the data is privacy preserving. In other words, when the data is received in step 202 an indication may be to store the data in a part of information repository 114 that has privacy preserving enabled. In an alternative embodiment, the metadata of the data may include an indication that the data is private data and therefore the data should have the privacy preserved. In an alternative embodiment, the data, when received, may include an indication from the user wanting to store the data that the data is privacy preserving. In an embodiment, if security program 112 determines the data is not privacy preserving (decision step 204, no branch), processing proceeds to step 206. In an embodiment, if security program 112 determines the data is privacy preserving, (decision step 204, yes branch), processing proceeds to step 208.

Security program 112 stores data (step 206). At step 204, security program 112 stores the data received in step 202 with no modification to the data. In an embodiment, security program 112 stores the data in information repository 114.

Security program 112 encrypts the data (step 208). At step 204, security program 112 encrypts the data using the public key that was provided in step 202. Here, the private key pair associated with public key would be held by the sender of the data or anyone with control of the data. In an alternative embodiment, security program 112 may encrypt the data using any known encryption techniques in the art. In an embodiment, another program and/or computing device (not shown) may encrypt the data and return the encrypted data to security program 112.

Security program 112 anonymizes data (step 210). At step 204, security program 112 anonymizes the data, including but not limited to, de-identifying the data. In an embodiment, security program 112 may use any known anonymization techniques in the art from basic to more advanced techniques. In an embodiment, security program 112 may apply anonymization techniques that replace the original data value (i.e., the personal/sensitive data) with a redacted form. For example. “John Smith” is replaced with “J***** S*****’. In another example, a date of birth of “1982” may be replaced with a bin value, such as “1980-1985”. In yet another example, the original value, “John Smith” may be replaced with a fictional value, “Marco Rossi” or a randomly generated name. In an embodiment, security program 112 may apply anonymization techniques that include, but are not limited to, K-Anonymity models, differential privacy, etc. In an embodiment, another program and/or computing device (not shown) may anonymize the data and return the anonymized data to security program 112. In an embodiment, the anonymized data may allow for data analytics to be conducted on the anonymize data. In other words, the anonymized data allows for data analytics to be run on important information without comprising the confidentiality of personal and/or sensitive information.

Security program 112 stores the encrypted and anonymized data (step 212). At step 204, security program 112 stores the data that has been encrypted in step 208 and anonymized in step 210. In an embodiment, security program 112 stores the data in information repository 114.

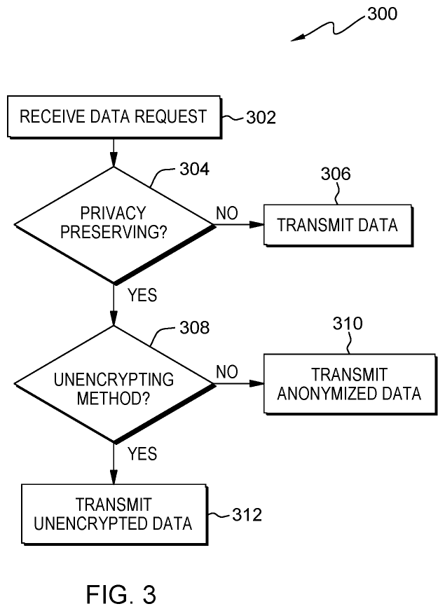

FIG. 3 is a flow chart diagram of workflow 300 depicting operational steps for security program 112 for providing private data in accordance with at least one embodiment of the invention. In an alternative embodiment, the steps of workflow 300 may be performed by any other program (not shown) while working with security program 122. It should be appreciated that embodiments of the present invention provide at least for providing private data. However, FIG. 3 provides only an illustration of one implementation and does not imply any limitations with regard to the environments in which different embodiments may be implemented. Many modifications to the depicted environment may be made by those skilled in the art without departing from the scope of the invention as recited by the claims. In a preferred embodiment, a user, via a user interface (not shown), can invoke workflow 300 upon a user wanting to access data.

Security program 112 receives a data request (step 302). At step 302, security program 112 receives a request for one or more data found in information repository 114. In an embodiment, a user, via the user interface discussed above, may indicate to security program 112 the data that the user would like to access. In an alternative embodiment, another program (not shown) may communicate via network 120 to security program 112 indicating the data that the program would like to access.

Security program 112 determines whether the requested data is privacy preserving (decision step 304). In other words, security program 112 determines whether the data being requested has been stored to have the privacy of the data preserved. In an embodiment, security program 112 determines where the data is to be stored and that storage location determines whether the data was stored as privacy preserving. In an alternative embodiment, the metadata of the data being requested may include an indication that the data is private data and therefore the data has been stored with the privacy preserved. In an alternative embodiment, the data, when stored, may have included an indication from the user wanting to store the data that the data is privacy preserving and therefore the data was stored with the privacy preserved. In an embodiment, if security program 112 determines the requested data is not privacy preserving (decision step 304, no branch), processing proceeds to step 306. In an embodiment, if security program 112 determines the requested data is privacy preserving, (decision step 304, yes branch), processing proceeds to step 308.

Security program 112 transmits data (step 306). At step 306, security program 112 transmits the data requested to the requesting party. In an embodiment, security program 112 may display the data requested on the user interface of computing device 110 for viewing by a user. In an embodiment, security program 112 may transmit the data to the requested computing device (not shown) over network 120.

Security program 112 determines whether the data request included an unencrypting method (decision step 308). In other words, security program 112 determines whether when the data was requested in step 302 if the request included a method to unencrypt the data. For example, did the data request include a private key that is a pair of a public key used to encrypt the requested data. In an embodiment, if security program 112 determines the data request did not include an unencrypting method (decision step 308, no branch), processing proceeds to step 310. In an embodiment, if security program 112 determines the data request did include an unencrypting method (decision step 308, yes branch), processing proceeds to step 312.

Security program 112 transmits anonymized data (step 310). At step 310, security program 112 transmits the data requested in anonymized form to the requesting party. In other words, the data has been anonymized in step 210 and therefore the data does not contain any personal information by using the one or more anonymizing techniques found in step 210. In an embodiment, security program 112 may display the data requested on the user interface of computing device 110 for viewing by a user. In an embodiment, security program 112 may transmit the data to the requested computing device (not shown) over network 120.

Security program 112 transmits unencrypted data (step 312). At step 312, security program 112 transmits the data requested in unencrypted form to the requesting party. In an embodiment, security program 112 may unencrypt the data using the unencrypting method received in step 302. In an embodiment, security program 112 may display the data requested on the user interface of computing device 110 for viewing by a user. In an embodiment, security program 112 may transmit the data to the requested computing device (not shown) over network 120. In an embodiment, the unencrypted data may allow the requester to obtain, process, and/or update the raw data. In an embodiment, the unencrypted data is transmitted in the “trusted” server environment. In other words, security program 112 unencrypts the data, alone or in collaboration with another program/computing device (not shown) and the unencrypted data is transmitted. In an alternative embodiment, the encrypted data is transmitted in the “untrusted” server environment. In other words, security program 112 transmits the encrypted data because the server is “untrusted” and when the client device (not shown) receives the data the client device unencrypts the data using another program/computing device (not shown).

In an embodiment, such as the “untrusted” server embodiment, even if security program 112 does or does not receive an encrypting method in decision step 308, security program 112 may return both the anonymized data and/or the encrypted data to the requesting party.

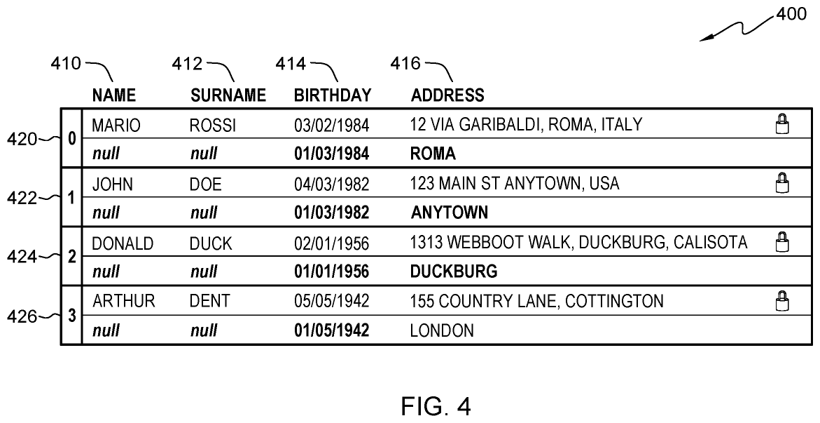

FIG. 4 is an example of encrypted and anonymized data 400, in accordance with at least one embodiment of the invention. In this example, the encrypted and anonymized data 400 includes four pieces of data, data 0 420, data 1 422, data 2 424, and data 3 426. In this example, each piece of data has a name 410, surname 412, birthday 414, and address 416. In this example, each piece of data includes a top row that has raw data that is encrypted and a bottom row that is anonymized to remove name 410 and surname 412. Additionally, each piece of data includes a bottom row that has randomized birthday 414 along with anonymized/simplified address 416. In this example, if an encryption method is received, security program 112 will transmit the top row of each piece of data and if an encryption method is not received, security program 112 will transmit the bottom row of each piece of data that will be in an anonymized form.

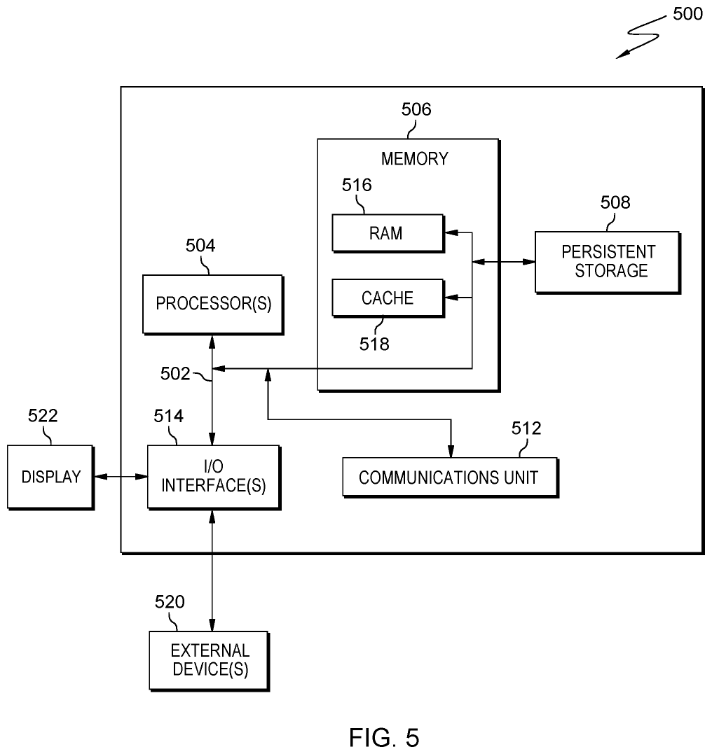

FIG. 5 is a block diagram depicting components of a computer 500 suitable for security program 112, in accordance with at least one embodiment of the invention. FIG. 5 displays the computer 500, one or more processor(s) 504 (including one or more computer processors), a communications fabric 502, a memory 506 including, a RAM 516, and a cache 518, a persistent storage 508, a communications unit 512, I/O interfaces 514, a display 522, and external devices 520. It should be appreciated that FIG. 5 provides only an illustration of one embodiment and does not imply any limitations with regard to the environments in which different embodiments may be implemented. Many modifications to the depicted environment may be made.

As depicted, the computer 500 operates over the communications fabric 502, which provides communications between the computer processor(s) 504, memory 506, persistent storage 508, communications unit 512, and input/output (I/O) interface(s) 514. The communications fabric 502 may be implemented with an architecture suitable for passing data or control information between the processors 504 (e.g., microprocessors, communications processors, and network processors), the memory 506, the external devices 520, and any other hardware components within a system. For example, the communications fabric 502 may be implemented with one or more buses.

The memory 506 and persistent storage 508 are computer readable storage media. In the depicted embodiment, the memory 506 comprises a random-access memory (RAM) 516 and a cache 518. In general, the memory 506 may comprise any suitable volatile or non-volatile one or more computer readable storage media.

Program instructions for security program 112 may be stored in the persistent storage 508, or more generally, any computer readable storage media, for execution by one or more of the respective computer processors 504 via one or more memories of the memory 506. The persistent storage 508 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of the persistent storage 508.

The communications unit 512, in these examples, provides for communications with other data processing systems or devices. In these examples, the communications unit 512 may comprise one or more network interface cards. The communications unit 512 may provide communications through the use of either or both physical and wireless communications links. In the context of some embodiments of the present invention, the source of the various input data may be physically remote to the computer 500 such that the input data may be received, and the output similarly transmitted via the communications unit 512.

The I/O interface(s) 514 allow for input and output of data with other devices that may operate in conjunction with the computer 500. For example, the I/O interface 514 may provide a connection to the external devices 520, which may be as a keyboard, keypad, a touch screen, or other suitable input devices. External devices 520 may also include portable computer readable storage media, for example thumb drives, portable optical or magnetic disks, and memory cards. Software and data used to practice embodiments of the present invention may be stored on such portable computer readable storage media and may be loaded onto the persistent storage 508 via the I/O interface(s) 414. The I/O interface(s) 514 may similarly connect to a display 522. The display 522 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for managing data, the computer-implemented method comprising:
receiving, by one or more computer processors, one or more pieces of data;
anonymizing, by one or more computer processors, the one or more pieces of data;
encrypting, by one or more computer processors, the one or more pieces of data;
storing, by one or more computer processor, the anonymized one or more pieces of data and the encrypted one or more pieces of data.

2. The computer-implemented method of claim 1, further comprising:
receiving, by one or more computer processors, a data request, wherein the data request includes at least part of the one or more pieces of data;
transmitting, by one or more computer processors, the anonymized one or more pieces of data and the encrypted one or more pieces of data of the data request.

3. The computer-implemented method of claim 1, further comprising:
receiving, by one or more computer processors, a data request, wherein the data request includes at least part of the one or more pieces of data;
determining, by one or more computer processors, whether the data request includes a unencrypting method for the one or more pieces of data;
responsive to the data request including the unencrypting method, transmitting, by one or more computer processors, the anonymized one or more pieces of data and the encrypted one or more pieces of data of the data request.

4. The computer-implemented method of claim 1, further comprising:
receiving, by one or more computer processors, a data request, wherein the data request includes at least part of the one or more pieces of data;
determining, by one or more computer processors, whether the data request includes a unencrypting method for the one or more pieces of data;
responsive to the data request not including the unencrypting method, transmitting, by one or more computer processors, the anonymized one or more pieces of data of the data request.

5. The computer-implemented method of claim 1, wherein the anonymized data allows for data analytics to be performed without comprising personal information within the one or more pieces of data.

6. The computer-implemented method of claim 1, wherein the one or more pieces of data are encrypted using a public/private key pair.

7. The computer-implemented method of claim 1, wherein the one or more pieces of data are anonymized using K-Anonymity models.

8. A computer program product for managing data, the computer program product comprising:
one or more computer readable storage media; and
program instructions stored on the one or more computer readable storage media, the program instructions comprising:
program instructions to receive one or more pieces of data;
program instructions to anonymize the one or more pieces of data;
program instructions to encrypt the one or more pieces of data;
program instructions to store the anonymized one or more pieces of data and the encrypted one or more pieces of data.

9. The computer program product of claim 8, further comprising one or more of the following program instructions, stored on the one or more computer readable storage media, to:
receive a data request, wherein the data request includes at least part of the one or more pieces of data;
transmit the anonymized one or more pieces of data and the encrypted one or more pieces of data of the data request.

10. The computer program product of claim 8, further comprising one or more of the following program instructions, stored on the one or more computer readable storage media, to:
receive a data request, wherein the data request includes at least part of the one or more pieces of data;
determine whether the data request includes a unencrypting method for the one or more pieces of data;
responsive to the data request including the unencrypting method, transmit the anonymized one or more pieces of data and the encrypted one or more pieces of data of the data request.

11. The computer program product of claim 8, further comprising one or more of the following program instructions, stored on the one or more computer readable storage media, to:
receive a data request, wherein the data request includes at least part of the one or more pieces of data;
determine whether the data request includes a unencrypting method for the one or more pieces of data;
responsive to the data request not including the unencrypting method, transmit the anonymized one or more pieces of data of the data request.

12. The computer program product of claim 8, wherein the anonymized data allows for data analytics to be performed without comprising personal information within the one or more pieces of data.

13. The computer program product of claim 8, wherein the one or more pieces of data are encrypted using a public/private key pair.

14. The computer program product of claim 8, wherein the one or more pieces of data are anonymized using K-Anonymity models.

15. A computer system for managing data, the computer system comprising:
one or more computer processors;
one or more computer readable storage media; and
program instructions, stored on the one or more computer readable storage media for execution by at least one of the one or more computer processors, the program instructions comprising:
program instructions to receive one or more pieces of data;
program instructions to anonymize the one or more pieces of data;
program instructions to encrypt the one or more pieces of data;
program instructions to store the anonymized one or more pieces of data and the encrypted one or more pieces of data.

16. The computer system of claim 15, further comprising one or more of the following program instructions, stored on the one or more computer readable storage media for execution by at least one of the one or more computer processors, to:
receive a data request, wherein the data request includes at least part of the one or more pieces of data;
transmit the anonymized one or more pieces of data and the encrypted one or more pieces of data of the data request.

17. The computer system of claim 15, further comprising one or more of the following program instructions, stored on the one or more computer readable storage media for execution by at least one of the one or more computer processors, to:
receive a data request, wherein the data request includes at least part of the one or more pieces of data;
determine whether the data request includes a unencrypting method for the one or more pieces of data;
responsive to the data request including the unencrypting method, transmit the anonymized one or more pieces of data and the encrypted one or more pieces of data of the data request.

18. The computer system of claim 15, further comprising one or more of the following program instructions, stored on the one or more computer readable storage media for execution by at least one of the one or more computer processors, to:
receive a data request, wherein the data request includes at least part of the one or more pieces of data;
determine whether the data request includes a unencrypting method for the one or more pieces of data;
responsive to the data request not including the unencrypting method, transmit the anonymized one or more pieces of data of the data request.

19. The computer system of claim 15, wherein the anonymized data allows for data analytics to be performed without comprising personal information within the one or more pieces of data.

20. The computer system of claim 15, wherein the one or more pieces of data are encrypted using a public/private key pair.
